(19) United States
(12) Patent Application Publication
(10) Pub. No.: US 2008/0320314 A1
(43) Pub. Date: Dec. 25, 2008

(54) APPARATUS FOR WRITING DATA TO A MEDIUM

(76) Inventors: Andreas Eckleder, Malsch (DE); Richard Lesser, Karlsruhe (DE); Reiner Kopf, Straubenhardt (DE)

Correspondence Address: GLENN PATENT GROUP, 3475 EDISON WAY, SUITE L, MENLO PARK, CA, 94025, US

(21) Appl. No.: 11/829,827

(22) Filed: Jul. 27, 2007

Related U.S. Application Data
(63) Continuation of application No. PCT/EP2007/003656, filed on Apr. 25, 2007.

(30) Foreign Application Priority Data
Apr. 13, 2007 (EP) 07007647.6

(51) Int. Cl. H04L 9/06

(52) U.S. Cl. 713/189

(57) ABSTRACT

An apparatus for writing data to a medium. The apparatus has a receiver for receiving a write request and encrypted data from a data provider. The apparatus further has a creator for creating a medium ID upon reception of the write request. Furthermore, the apparatus has a provider for providing the medium ID to the data provider for generating the encrypted data and a storage for storing the encrypted data on the medium and for storing the medium ID on the medium upon creation of the medium ID, wherein the encrypted data is encrypted based on the medium ID.

### CROSS-REFERENCE TO RELATED APPLICATIONS

This application is a continuation of copending International Application No. PCT/EP2007/003656, which was filed on Apr. 25, 2007, which designated the United States.

### TECHNICAL FIELD

The present invention is in the field of data security and data protection, especially on portable media.

### BACKGROUND

Copy protection and data security is an issue that has gained more significance with the success of digital data and media. In present times as penetration of personal computers includes private households, copy protection and data security is even more an issue. Every year significant economical losses occur due to pirated data. Moreover, it is in the interests of any user of digital media to secure and protect private content, which includes copy protection as well as integrity and encryption mechanisms.

For instance, in conventional computer systems it is rather simple to copy digital content, however some copy protection mechanisms exist that can at least hinder product piracy. However, it is rather complicated, if not impossible, for a private user to write private data that is copy protected. Some mechanisms are known to encrypt private data as, for example, PGP (PGP=Pretty Good Privacy). With these mechanisms, data can be encrypted using a private encryption key, using a public encryption key the data can be verified to have been encrypted with the private encryption key. Encryption works the other way around, encrypting digital content with a public encryption key allows the holder of the private encryption key to decrypt the digital content. These mechanisms do, however, have the problem, that they are complex and still lack proper copy protection.

### SUMMARY

According to an embodiment, an apparatus for writing data to a medium may have a means for receiving a write request and encrypted data from a data provider. The apparatus further comprises a means for creating a medium ID (ID=Identity) upon reception of the write request and a means for providing the medium ID to the data provider for generating the encrypted data. The apparatus further comprises a means for storing the encrypted data on the medium and for storing the medium ID on the medium, upon creation of the medium ID, wherein the encrypted data is encrypted based on the medium ID.

According to another embodiment, a method for writing data to a medium may have the steps of: receiving a write request from a data provider; creating a medium ID upon reception of the write request; providing the medium ID to the data provider for generating the encrypted data; receiving the encrypted data from the data provider; and storing the encrypted data on the medium and storing the medium ID on the medium upon creation of the medium ID, wherein the encrypted data is encrypted based on the medium ID.

An embodiment may have a computer program having a program code for performing the method for writing as mentioned above when the program code runs on a computer.

According to another embodiment, an apparatus for providing encrypted data to a data writer may have a means for sending a write request to the data writer and a means for receiving the medium ID from the data writer upon sending the write request to the data writer. The apparatus for providing further comprises a means for encrypting plain text data using an encryption key to obtain the encrypted data, the encryption key being based on the medium ID and the means for sending is further adapted for sending the encrypted data to the data writer.

According to another embodiment, a method for providing encrypted data to a data writer, may have the steps of: sending a write request to the data writer; receiving an ID from the data writer upon sending the write request; encrypting plain text data using an encryption key to obtain the encrypted data, the encryption key being based on the medium ID; and sending the encrypted data to the data writer.

An embodiment may have a computer program having a program code for performing the method for providing as mentioned above, when the computer program runs on a computer.

An embodiment may have an optical drive comprising an apparatus for writing data as mentioned above and an apparatus for providing encrypted data as mentioned above.

Embodiments are based on the finding, that copy protection can be achieved, by encrypting digital content which is stored on a storage medium, wherein the encryption is based on an encryption key having multiple encryption ingredients. One of the encryption ingredients can be an ID, which may be unique in an embodiment, and which is written to the storage medium as well. The medium ID written to the storage medium can only be generated by an embodiment upon receipt of a write request. Once the medium ID is created, it is provided to a data provider, which can in one embodiment be implemented by an application running, for example, on a PC (PC=Personal Computer). The application then encrypts the data based on the medium ID and further based on, for example, a password, a revocation key, etc. The encrypted data is then written to the storage medium by the data writer. Whenever the data is read, the medium ID is read from the storage medium and provided to a reader application, which reassembles the encryption key with the involved key ingredients, and decrypts the data. However, the data writer does not write a medium ID, which has not been generated by itself, but provided from any application from the outside. Moreover in another embodiment, application and writer can be implemented in, for example, an optical drive.

Embodiments may provide a complete set of solutions allowing the encryption of content to facilitate copy protection and content access control, as well as increased data reliability through redundancy. While content access control is accomplished by encrypting data stored on e.g. an optical disc using a user-supplied password, copy protection allows the user to prevent others from creating copies of such a medium. Combined with the possibilities of storing data redundantly and digitally signing the data to prove authenticity, all of these possibilities provide enterprises and private end users with a means necessary to share data securely using e.g. optical disc media. A user can then control who has access to the data by protecting it, for example with a password, and the user can also be sure that no unauthorized copy of the content is made.

In another embodiment the above-described mechanism is combined with a password, where in one embodiment the password may be combined with the medium ID and the result may also be written to the storage medium. A user then has the possibility of controlling the copy protection at a later point, which is supposing that the password is known. Some embodiments provide the advantage that legacy storage media and legacy readers or writers are not affected. If data is not copy protected, legacy readers could still read it, data written with a legacy writer could still be read by an embodiment.

Some embodiments therewith provide protection against unauthorized copying, not only in terms of copyright protection, but also in regard to the distribution and storage of confidential material. Embodiments allow the user to effectively reduce the risk for confidential information to leak into the public or entering the hands of unauthorized third parties by copy protection.

Embodiments allow encrypting the content that needs to be protected and storing the key on a part of the media that cannot be copied, using soft- or hardware available on the market. Access to copy protected materials will be available through embodiments of dedicated viewer or reader applications that can e.g. be provided for installation from an unencrypted part of a protected disc.

### BRIEF DESCRIPTION OF THE DRAWINGS

Embodiments will be described in detail in the following using the accompanying figures, in which:

FIG. 1a shows an embodiment of an apparatus for writing;

FIG. 1b shows an embodiment of a storage medium;

FIG. 2 shows another embodiment of an apparatus for writing;

FIG. 3a shows an embodiment of an apparatus for providing encrypted data;

FIG. 3b shows another embodiment of an apparatus for providing encrypted data;

FIG. 4 shows an embodiment of a cryptographic system;

FIG. 5 shows an embodiment of an optional node key structure;

FIG. 6 shows an embodiment of a medium ID structure;

FIG. 7 shows an embodiment of an anchor structure;

FIG. 8 shows an embodiment of a file fragment information table structure;

FIG. 9 shows an embodiment of a file fragment information table entry structure;

FIG. 10 shows an embodiment of a copy protection field structure;

FIG. 11 shows an embodiment of a feature descriptor and feature control field structure;

FIG. 12 shows an embodiment of a drive host authentication;

FIG. 13 shows an embodiment of a REPORT KEY command;

FIG. 14 shows an embodiment of a reply packet to a REPORT KEY command;

FIG. 15 shows an embodiment of a reply packet to a KEY CONTRIBUTION command;

FIG. 16 shows an embodiment of a reply packet to a DISC UNIQUE ID command;

FIG. 17 shows an embodiment of a SEND KEY command;

FIG. 18 shows an embodiment of an information packet attached to a SEND KEY HOST RANDOM NUMBER AND PROTOCOL VERSION command;

FIG. 19 shows an embodiment of a flow chart for an initialization and feature detection procedure for a data reader implementation;

FIG. 20 shows an embodiment of a flow chart of an initialization and feature detection procedure for a writer implementation;

FIG. 21 shows an embodiment of a feature flag mask for copy protection;

FIG. 22 shows an embodiment of a flow chart of a calculation of a copy protection state; and

FIG. 23 shows an embodiment of a flow chart of an optical disc drive state chart.

### DETAILED DESCRIPTION

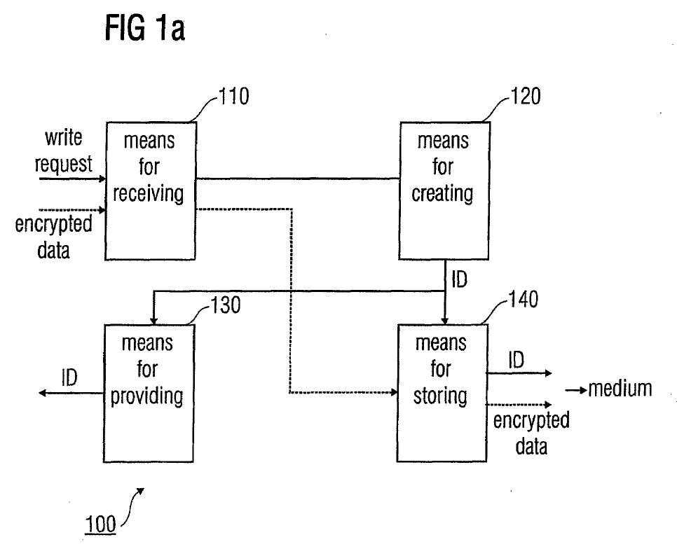

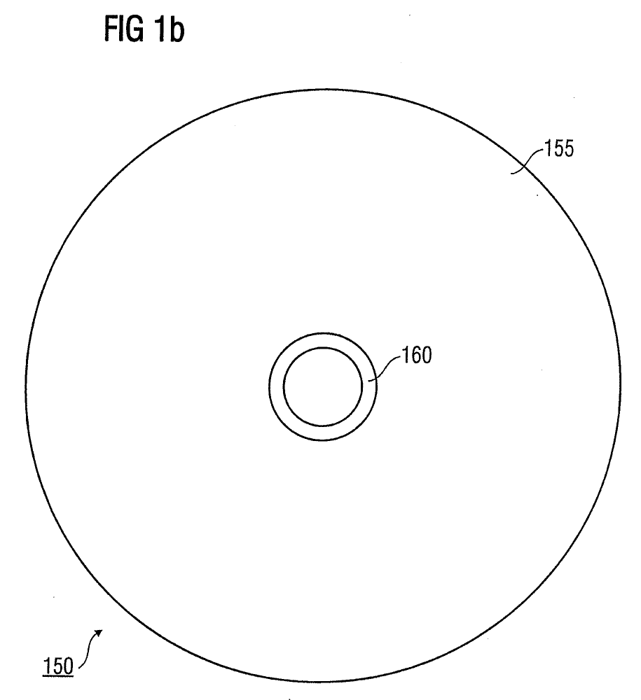

FIG. 1a shows an embodiment for an apparatus 100 for writing data to a medium. The apparatus 100 comprises a means 110 for receiving a write request and encrypted data from a data provider. Furthermore, the apparatus 100 comprises a means 120 for creating a medium ID upon receipt of the write request. The apparatus 100 further comprises a means 130 for providing the medium ID to the data provider for generating the encrypted data and a means 140 for storing the encrypted data on a medium and for storing the medium ID on the medium upon creation of the medium ID, wherein the encrypted data is encrypted based on the medium ID.

In some embodiments the means 140 can be adapted for storing the encrypted data in a data section and the medium ID in an ID section on the medium, wherein the data section is isolated or separated from the ID section. FIG. 1b shows an embodiment of a medium 150, which is exemplified as a disc, for example an optical disc, such as a CD (CD=Compact Disc), DVD (DVD=Digital Versatile Disc), or Blue-Ray disc, etc. The medium 150 depicted in FIG. 1b shows a data section 155 and an ID section 160. In one embodiment, the ID section is in a place of the medium, where only an embodiment has access. In other words, the ID section may, in embodiments, be in a physical place that is not accessible by legacy writers. The medium depicted in FIG. 1b is one embodiment, but several other realizations of ID section 160 and data section 155 are conceivable, which are separated on the disc or other media as for instance USB-memory-devices (USB=Universal Serial Bus), memory cards etc.

In other embodiments the means for storing 140 can be adapted for storing only a medium ID in the ID section 160, subsequently to creating the medium ID by the means 120 for creating a medium ID. The means 120 for creating the medium ID may be adapted for generating the ID utilizing a random or pseudo random number. In another embodiment the means 140 for storing can be adapted for storing a combination of the medium ID and a password on the medium.

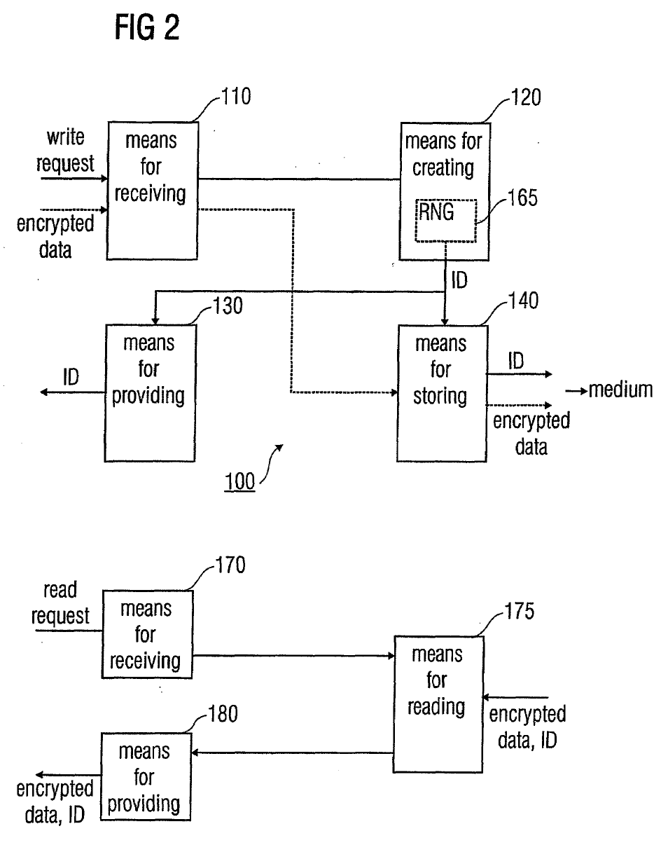

FIG. 2 shows another embodiment of an apparatus 100 for writing. In the embodiment depicted in FIG. 2, the means 120 for creating the medium ID comprises a random number generator (RNG=Random Number Generator) 165, which can in another embodiment also be a pseudo random number generator. The embodiment depicted in FIG. 2 further comprises a means 170 for receiving a read request, a means 175 for reading a medium ID and encrypted data from the medium and, moreover, a means 180 for providing the medium ID and the encrypted data. In another embodiment the means for receiving 110 and the means for receiving 170 can be implemented together. In a similar way, the means 130 for providing and the means 180 for providing may be implemented together. Moreover, the apparatus 100 for writing may be implemented in a chip or ROM (ROM=Read Only Memory), which could be comprised in an optical drive.

In another embodiment of an apparatus 100, a means for authenticating may be comprised for authenticating with a data provider or a data reader. Moreover, the means 110 for receiving may be adapted for receiving an encrypted write request from a data provider and for decrypting the write request. Consequently, the means 170 for receiving a read request can be adapted for receiving an encrypted read request and for decrypting the encrypted read request. Consequently, the means 130 and 180, for providing may be adapted for encrypting the medium ID and for providing the encrypted medium ID to a data provider or a data reader.

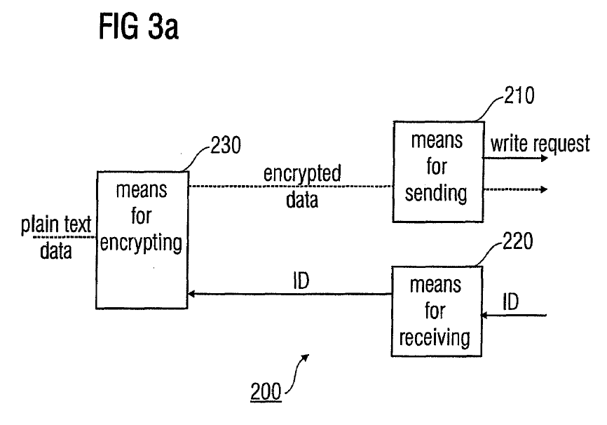

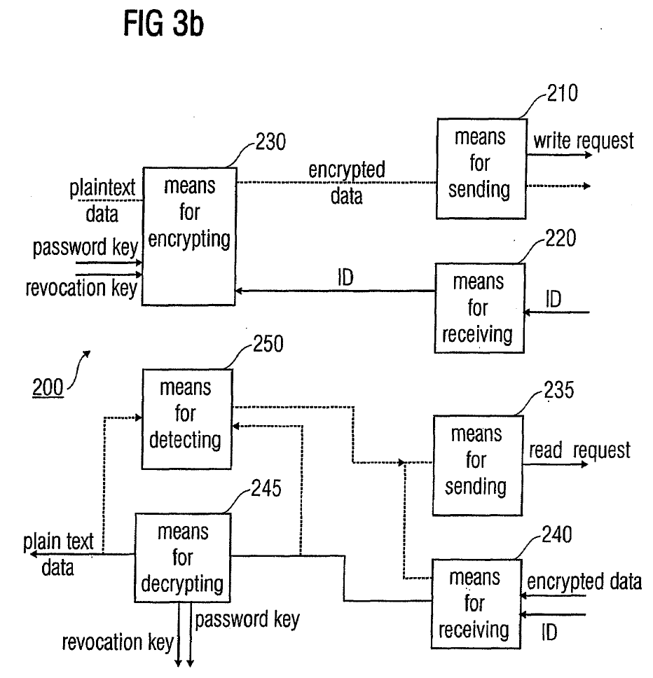

FIG. 3a shows an embodiment of an apparatus 200 for providing encrypted data to a data writer. The apparatus 200 comprises a means 210 for sending a write request to the data writer and a means 220 for receiving a medium ID from the data writer upon sending the write request. Furthermore, the apparatus 200 comprises a means 230 for encrypting plain text data using an encryption key to obtain the encrypted data, the encryption key being based on the medium ID and wherein the means 210 for sending is adapted for sending the encrypted data to the data writer.

In one embodiment the means 230 for encrypting is further adapted for using an encryption key, which is further based on a password. For example, the encryption key may result from an XOR operation between the medium ID and the password and possibly other key ingredients. In another embodiment the means 230 for encrypting may be adapted for using an encryption key, being further based on a revocation key. In one embodiment the encryption key may be an XOR operation between the three of a medium ID, a password and a revocation key.

FIG. 3b depicts another embodiment of an apparatus 200 for providing encrypted data to a data writer. FIG. 3b depicts similar components as FIG. 3a, however, further comprising a means 235 for sending a read request to the data writer, a means 240 for receiving encrypted data and a medium ID and a means 245 for decrypting data based on a decryption key to obtain plain text data. In one embodiment the means 245 for decrypting may be adapted for using a decryption key being based on a medium ID, a password or a revocation key. In an embodiment the decryption key may be based on an XOR operation between the medium ID, a password or a revocation key.

In embodiments the means 210 for sending and the means 235 for sending may be implemented together. In a similar way, the means 220 for receiving and the means 240 for receiving may be implemented together. In another embodiment the means 230 for encrypting may be further adapted for encrypting an information on an encrypted password in the data. In another embodiment the apparatus 200 further comprises a means 250 for detecting a copy protection indication from the encrypted data or the plain text data. The means 210 for sending may be adapted for not sending a write request, when a copy protection indication is detected. In a similar way, the means 220 for receiving the medium ID may be adapted for not receiving a medium ID when the copy protection indication is detected and the means 230 for encrypting may be adapted for not encrypting data, when the copy protection indication is detected. In another embodiment the copy protection indication corresponds to control information within the encrypted or plain text data, the encrypted or plain text data having plain text control information.

In another embodiment, similar to what has been said above, the apparatus 200 for providing encrypted data may further comprise a means for authenticating with a data writer, and the means 210 and 235 for sending can be adapted for sending encrypted read or write requests and, accordingly, the means 220 and 240 for receiving can be adapted for receiving an encrypted medium ID.

In another embodiment system may comprise an apparatus 100 for writing data and an apparatus 200 for providing encrypted data according to the above embodiments. Moreover, the system may be comprised in an optical drive, and the medium may correspond to an optical storage medium such as a CD, DVD or Blue-Ray disc.

Embodiments enable copy protection, by making sure that parts of, for example a disc cannot be copied using available software/recorder commands. To accomplish this goal, embodiments generate medium IDs for each disc when it is first used with an embodiment. In embodiments the medium IDs can be unique respectively an identical medium IDs repeats or is generated very rarely. In the following the medium ID is also called unique ID, indicating that these IDs repeat very rarely. The unique ID can be in one embodiment 128-bit random number to be generated by the embodiment's firmware or random number generator, or pseudo random generator, when the copy protection feature is applied to a particular disc for the first time. Although the unique ID may not be definitely unique, as there's a probability of repetition when drawing the e.g. 128-bit numbers, they may be called unique in the following.

A unique ID is then written to a location on the disc than cannot be copied without modifications to the writer, e.g. to the firmware. Such locations can include the lead in of DVDs. The unique ID will be read out by e.g. the firmware and used for calculating a content access key and, once the content access key has been verified, it can be requested by a host application through dedicated multimedia read commands. It will be then transferred to the host application protected by a bus key that has previously been established using drive host authentication. The unique ID will be lost during a copying process from one medium to another. Without the corresponding unique ID, the content cannot be decrypted. Therefore, a copy of such a media that has been protected against copying by using the unique ID as an access key ingredient will be useless, as the copy will not have the same unique ID. As already mentioned above, this mechanism can be combined with password protection in some embodiments.

In the following, a detailed embodiment will be described, which is called SecurDisc. Copy protection and access control are enabled by encrypting the data that is written to the media, such that only when the encryption key is known the drive or driver delivers the correct data. The encryption key is derived either from a user pass phrase, the DUID (DUID=Disc Unique ID), or both, and combined with a shared secret known only to authorized applications. This shared secret can be revoked in the case of an application being compromised, corresponding to a revocation key. The sources for building the revocation key are called Key Ingredientsₓ.

The DUID can be derived from the data writer, which will be referred to in the following as a drive, or optical drive. The DUID is not stored in the user data area of the disc, but on a special location chosen individually for each optical disc type, such that it cannot be copied without firmware modification, which is also called the ID section in the embodiments described above. SecurDisc does not necessitate any dedicated type of optical storage media.

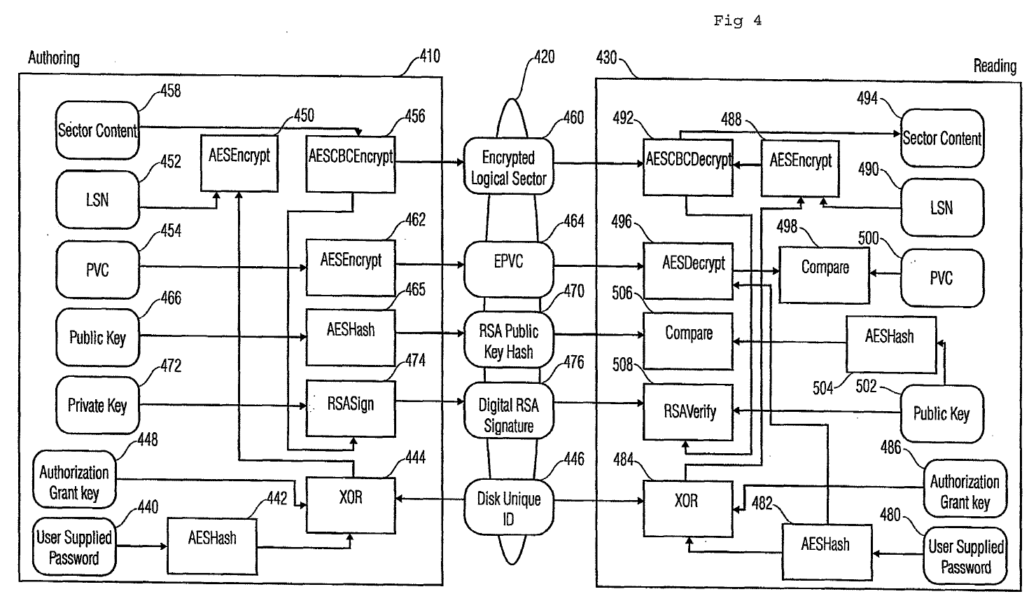

FIG. 4 illustrates an embodiment of a cryptographic system and provides an overview of the cryptographic system used for SecurDisc, however, not all components shown in FIG. 4 are relevant for embodiments enabling copy protection and access control. FIG. 4 shows components 410, which are utilized for authoring the content of the medium 420. Moreover, FIG. 4 shows components 430, which are utilized for reading the content of the medium 420.

Cryptographic functionality is comprised in both an optical drive and a host, with data read from and written to the media 420. FIG. 4 shows a diagram illustrating the cryptographic functionality necessary to protect a medium 420 against copying an unauthorized access and to digitally sign data.

One of the authoring components 410 is a user-supplied password 440, which is supplied to an AESHash 442 function (AES=Advanced Encryption Standard) creating a first key ingredient, which is provided to an XOR operational block 444. The XOR operational block 444 is further provided with a disc unique ID 446 and an authorization grant key 448, which specifies a key that is derived from a revocation block. Resulting from the XOR operational block 444, the encryption key is provided to the AES encryption block 450. The AES encryption block 450 further receives a logical sector number 452 and a pass phrase verification checksum (PVC=Pass phrase Verification Checksum) 454, which is a licensed value, used to verify the validity of the user's applied pass phrase. The output of the AES encryption block 450 is then provided to the AESCBC encryption block 456 (CBC=Cipher Block Chaining), which is a special mode of operation for block ciphers. The AESCBC encryption block 456 is further provided with a sector content 458, so an encrypted logical sector 460 can be written to the medium 420.

Another AES encryption block 462 derives an EPVC (EPVC=Encrypted PVC) 464 based on the PVC 454 and the AESHash 442. Based on a public key 466 another AESHash 468 provides an RSA public key hash 470 (RSA=Initials of Surnames of Inventors, Rivest, Shamir and Adleman). Using a private key 472, an RSA signature block 474, which is also based on the AESCBC encryption block 456 output, derives a digital RSA signature 476, which can also be stored on the medium 420.

On the reading side, similar components 430 can be found. From a user supplied password 480 and AESHash 482 can provide a key ingredient to an XOR operational block 484. The XOR operational block 484 further receives an authorization grant 486 and the disc unique ID 446 from the medium 420, in order to provide an encryption key to the AESEncryption block 488. Based on a logical sector number 490, the AESEncryption block 488 can provide a decryption key to the AESCBC decryption block 492, which can then decrypt the encrypted logical sector 460 and provide a sector content 494. An AESDecryption block 496 provides, based on the output of the AES hashing block 482 and the encrypted PVC 464 a decrypted PVC for comparison in block 498, which compares the value to the PVC 500, and enables a verification of the user pass phrase.

Based on a public key 502 and another AES hashing block 504, another comparison can be carried out in a comparison block 506 with an RSA hash key 470 from the medium 420. Based on the public key 502 and the output of the AESDecryption block 496 and RSA verification block 508 can verify the digital RSA signature 476 from the medium 420.

The authorization grant keys 448 and 486, specify a key that is derived from a revocation block, also called revocation key in the embodiments described above. A revocation block specifies a binary tree that will be traversed to obtain a revocation block node key. In some embodiments the input to the traversing function can be a 32-bit value, the function which traverses the bits of this value, starting with the most significant bit, as it traverses the binary tree. Starting at the root node, it will branch left if the current bit is set to, for example, the zero bit, and branch right if the current bit is set to the one bit, unless it encounters a node that does not have a left or a right child, depending on which one is necessary according to the current bit. If such a node carries a NK (NK=Key Node), this key is returned along with the current bit position within the 32-bit value. If the node does not carry a NK, the function aborts with an error indicating that the component associated with the 32-bit value has been revoked.

Once a revocation block NK is obtained, it can be used to create a final key value, when combined with a single entry or an entry or an array KC[] consisting of 32-keys. The entry is determined by the bit position x that was last processed when traversing the binary tree. The final key value K can be built using the following formula:

K=KESencrypt (KC[x], NK).

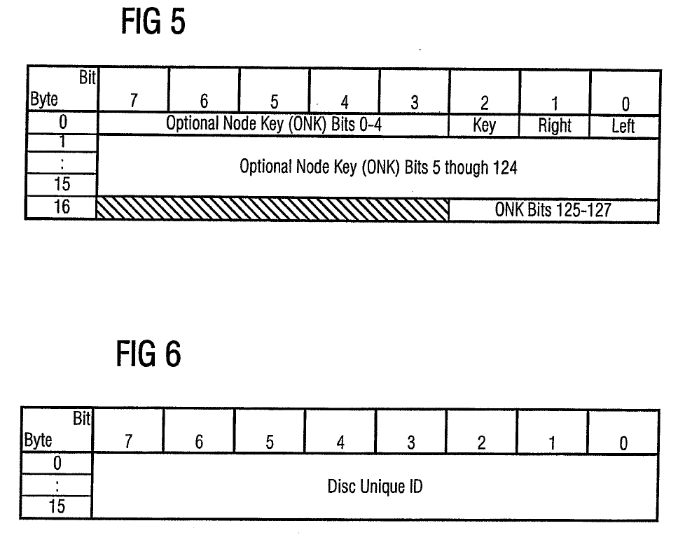

The binary tree is stored as a bit-stream, which is iterated when starting from the route node, e.g. in the sequence of parent, left child and right child. This means that when processing a node, first the current node is written out, then, the iteration process recursively continues with the left child node, if it exists. Finally, the iteration process recursively processes the child node. For example, for each node it writes out the structure depicted in FIG. 5. FIG. 5 shows a tabular notation, in which 8 bits or one byte are depicted in a row of the table and the number of rows correspond to the number of bytes within the structure. The structure will be detailed starting from the top right corner, which corresponds to the first bit of the structure and is labeled “left” in FIG. 5. In an embodiment, e.g. if this bit is set to one, this node has a left hand child node. The next bit is labeled “right” and e.g. if this bit is set to one, this node has a right hand child node. The bit labeled with “key” indicates that a node key immediately follows this bit. The fields labeled with “optional node key” specifies a 128-bit node key. This field is only present if the “key” bit immediately preceding this field, is set to one.

Media that have been written using one of the SecurDisc features may contain extra information specifying redundancy definitions, keys and identifiers used for data security and copy protection. Some of this information may be stored outside a user data area, as for example an ID section on an optical disc that supports SecurDisc copy protection. FIG. 6 shows an embodiment of a medium ID or disc unique ID. The disc unique ID shown in FIG. 6 is a 128-bit random number generated by an optical disc drive, when it is requested for the first time, on a write once, or sequential writing media when the area in which it is stored is written. A host can get access to the disc unique ID only by successfully completing drive host authentication, as it will be described below. The storage location on the disc unique ID depends on the physical media format. In the following, different media formats supported by SecurDisc will be detailed. For example, on DVD+R/+RW media, the disc may be stored in buffer zone 2, however, other locations may be possible. A storage location may be chosen which does not interfere with other copy protection technologies.

SecurDisc media may contain some of the information necessary for enhanced security and reliability in the user data area or data section 155, according to FIG. 2. This information can be file system independent and may also work with ISO 9660/Joliet and all flavors of UDF (UDF=Universal Data Format).

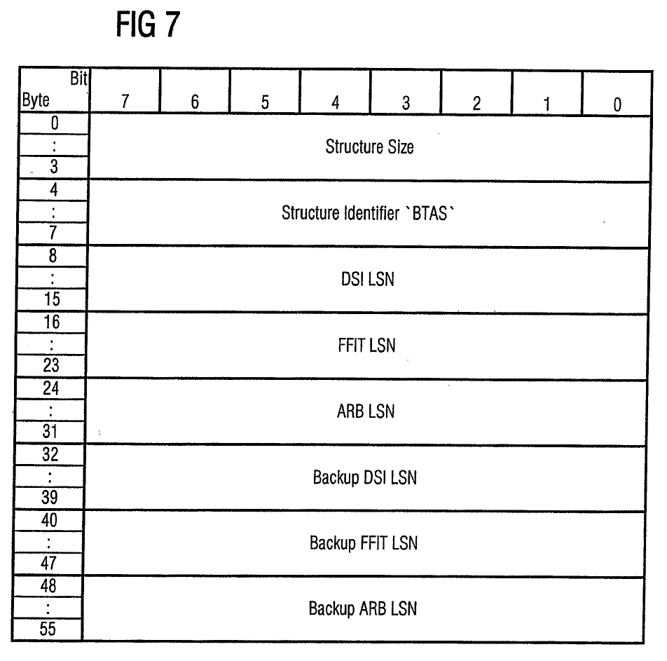

FIG. 7 shows a basic SecurDisc technology anchor structure (BTAS=Basic SecurDisc Technology Anchor Structure). The BTAS can e.g. be located in RLSN 15 (RLSN=Relative Logical Sector Number), relative to the beginning of a SecurDisc enabled recording session at offset RBP 64 (RBP=Relative Byte Position). Moreover, one redundant copy of BTAS can be located at either the last LSN of a SecurDisc enabled recording session, or the logical sector immediately preceding the secondary AVDP (AVDP=Anchor Volume Description Pointer). The BTAS references an FFIT (FFIT=File Fragment Information Table) and a redundancy information block, as well as a second redundancy backup copy of each of these structures, and thus serves as an anchor for all SecurDisc structures located in the user data area. FIG. 7 shows an embodiment of an exemplified BTAS.

FIG. 7 shows a field for the structure size which specifies the total size of the structure in bytes as a Big-Endian value, which can for example be 56-bytes. Moreover, FIG. 7 shows a structure identifier “BTAS”, which contains an ASCII (ASCII=American Standard Code for Information Interchange) representation of “BTAS” identifying the structure as a SecurDisc technology anchor structure.

The field DSILSN (DSI=Disc Security Information) specifies the logical sector number of the disc security information structure as a Big-Endian value. If this security information is not present, all bytes of this field are set to zero. Furthermore, FIG. 7 shows the FFITLSN, which specifies the logical sector number of the FFIT as a 64-bit Big-Endian value.

Another field shown in FIG. 7 is the ARBLSN (ARB=Application Revocation Lock) and specifies the logical sector number of ARB as a 64-bit Big-Endian value, or a field filled with zeros, if no ARB is present. The ARB is necessary in the embodiments for all media that use copy protection or pass phrase protection features of SecurDisc. An ARB is a revocation block, which can be used to revoke compromised applications.

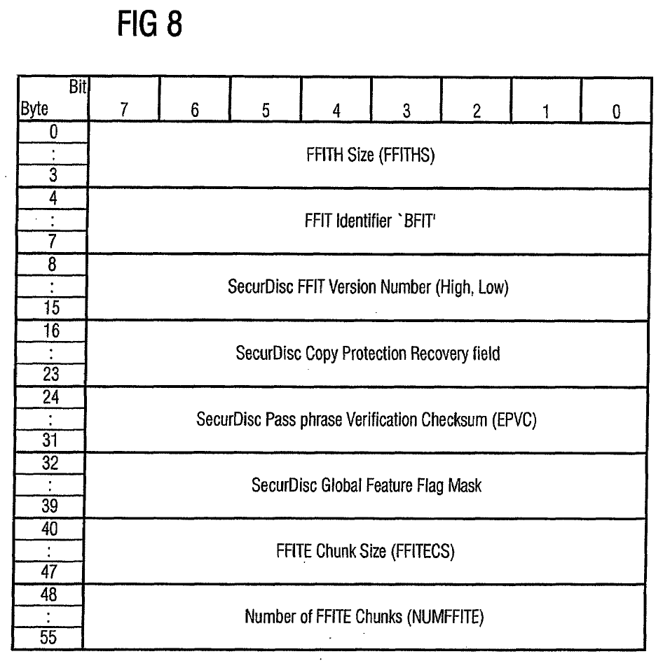

FIG. 7 further shows “Backup DSILSN”-, “Backup FFITLSN”- and “Backup ARBLSN”-fields, which specify the logical sector numbers of the respective backup structures. The FFIT contains information about each contiguous area of the disc that is managed by SecurDisc, such contiguous areas may include files that are copy protected or pass phrase protected, as well as files protected by checksums. The FFIT is stored after all other files on the disc, to allow checksums to be generated on-the-fly during the recording process. The location of the FFIT is flexible, the FFIT is referenced by the BTAS. It begins with a header and an embodiment of a structure is shown in FIG. 8.

Header information is comprised in the FFITH (FFITH=FFIT Header) field containing version information and a field indicating the different SecurDisc features that are used on any part of the media. A backup of the FFIT is referenced by the BTAS as mentioned above. Its location may be freely selected. However, to achieve maximum reliability, the backup FFIT should be physically distant from the first copy of the FFIT, as a minimum requirement, the backup FFIT can be stored in a packet different to the primary FFIT.

As indicated in FIG. 8, the structure starts with the “FFITH Size”-field (FFITHS=FFITH size), which specifies the total size of the FFITH and bytes as a Big-Endian value. In one embodiment the structure size may be 40 bytes. Moreover, FIG. 8 shows the FFIT identifier, which contains a ASCII representation of the string “BFIT” identifying the structure as a SecurDisc file fragment information table.

Moreover, FIG. 8 shows a SecurDisc FFIT version number, which specifies a version number of the structure. The first byte contains a high version number the second byte contains a low version number. The high version number is 01h in one embodiment. An implementation may only rely on the layout of the remaining information of the FFITH and its FFITE (FFITE=FFIT Entry) if the high version number is 01h. If only the low version number is higher than the version number an implementation supports, the implementation may still rely on the structures that have been defined in a previous version of an embodiment.

Furthermore, FIG. 8 shows a SecurDisc “Copy Protection Recovery”-field, which comprises the 128-bit disc unique ID encrypted with a 128-bit AES key value derived from a special copy protection recovery pass phase calculated as described above. There may be no pass phrase verification checksum for this value in another embodiment. If no copy protection recovery pass phrase has been specified during the authoring process all bytes of this field may be set to zero.

Moreover, FIG. 8 shows a SecurDisc pass phrase verification checksum, which comprises an 128-bit checksum that can be used to verify the correctness of the pass phrase entered by a user. The pass phrase verification checksum has a fixed value PVC, which can be encrypted using the key contribution derived from the user pass phrase, as it was described above.

Furthermore, there is a SecurDisc global feature flag mask in FIG. 8 comprising the result of an XOR operation, combining all feature flag masks of all FFITE of this FFIT. FIG. 8 also shows an FFITE chunk size, which is a 32-bit Big-Endian value in this embodiment, and all FFITE may be stored as a chunked information list with a fixed chunk size. At the bottom of the structure shown in FIG. 8 there is a number of FFITE chunks, which specifies the number of FFITE chunks contained in the file fragment information table as a 64-bit Big-Endian value. The chunk list of FFITE starts immediately after the FFITH, as depicted in FIG. 8.

The FFITH may grow as additional fields are added in further embodiments. The location of the FFITE can be calculated as

FFITEOFFSET[0]=FFITLSN*BPS+FFITHS

FFITELSN[0]=FFITEOFFSET[0] DIV BPS

FFITERBP[0]=FFITEOFFSET[0] MOD BPS

with FFITEOFFSET[0] being the relative bit position (RBP=Relative Bit Position) of the first FFITE relative to the beginning of the user data area of the disc, BPS is the number of bytes per sector and FFITELSN is the LSN of the FFIT.

The result of this operation is FFITELSN[0], the LSN of the first FFITE and FFITERBP[0], the relative byte position of the first FFITE from the beginning of the sector specified by the FFITELSN[0].

FFITE are stored in ascending order of their fragments' LSN. The location of a particular entry x is calculated as

FFITEOFFSET[x]=FFITEOFFSET[0]+x*FFITECS

FFITELSN[x]=FFITEOFFSET[x] DIV BPS

FFITERBP[x]=FFITEOFFSET[x] MOD BPS,

where FFITEOFFSET[x] is the RBP of the x-th FFITE relative to the beginning of the user data area of the disc, x is a number between 0 and NUMFFITE-1 and FFITECS is the FFITE content size.

The result of this operation is FFITELSN[x], the LSN of the x-th FFITE and FITERBP[x], the relative byte of the x-th FFITE from the beginning of the sector specified by FFITELSN[x].

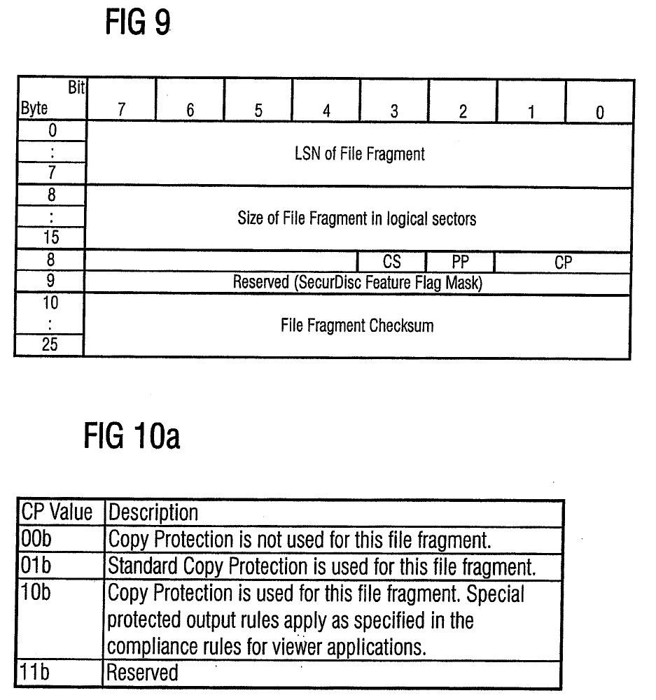

An embodiment of an FFITE structure is shown in FIG. 9. FIG. 9 shows an “LSN of File Fragment”-field, which specifies the LSN of the file fragment managed by the FFITE. Moreover, a field is dedicated to the size of the file fragment in logical sectors, specifying the size of the file fragment managed by the FFITE in logical sectors. A logical sector is the smallest logical unit for SecurDisc. If a sector is not used completely, the remaining space can be filled with zeros in this embodiment.

A pass phrase protected field “PP” comprises a flag, also being part of the SecurDisc feature flag mask. If true, the file fragment managed by this FFIT is pass phrase protected. The “CS”-field is also part of the SecurDisc feature flag mask. If true, the content of the file fragment managed by this FFITE can be verified using a “File Fragment Checksum”-field stored in this FFITE.

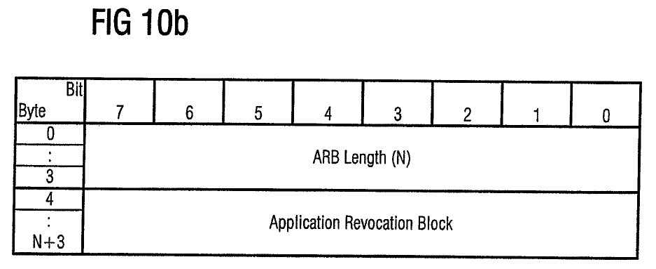

The “CP”-field is part of the SecurDisc feature flag mask. It can assume four distinct conditions regarding copy protection for the file fragment managed by this FFITE as specified in the Table in FIG. 10a. FIG. 10a shows an embodiment of the copy protection values, indicating whether copy protection is used or not for this file fragment, and whether special protected output rules apply.

FIG. 9 further shows the file fragment checksum in case the “CS”-flag is true, this field may contain a AES-128 cryptographic hash of the file fragment managed by this FFITE. If the CS flag is false, this field may contain all zeros. Moreover, FIG. 9 shows in row 9, a space that can be reserved for SecurDisc feature flag mask extensions.

FIG. 10b shows an embodiment of an application revocation block structure (ARB=Application Revocation Block). The primary and backup ARB are referenced by the BTAS. The allocation may be freely selected. However, to achieve maximum reliability, the backup ARB should be physically distant from the primary ARB copy. In one embodiment, the minimum requirement would be to store the backup ARB in a different packet than the primary ARB.

The application revocation block, as exemplified in FIG. 10b, may serve as a key ingredient and has two fields. According to FIG. 10b, the “ARB Length”-field specifies the length of the application revocation block in bytes as a Big-Endian WORD value. The “Application Revocation Block”-field specifies the application revocation block in the format of a revocation block, as described above.

All communication between an ODD and a host may take place using extensions to existing MtFuji and MMC commands or new commands. Some constants and identifiers in embodiments have been assigned temporary values but may be assigned different values in a standardization process, embodiments may use official identifiers and constants. Embodiments are therefore not restricted to the absolute values mentioned in this specification.

Part of an embodiment of SecurDisc, can be that a SecurDisc feature descriptor allows the host to determine whether SecurDisc is supported by an optical disc drive and whether the optical disc currently in the drive can be used with SecurDisc. In an embodiment the feature will be set to active regardless of whether an optical disc has already been written to using SecurDisc or not. An optical disk drive (ODD=Optical Disk Drive) may support a GET CONFIGURATION command as specified by the MMC/MtFuji (MMC=Multimedia Command) specification and it may be used to obtain the feature descriptor from the ODD. The execution of this command may not be necessary prior drive host authentication.

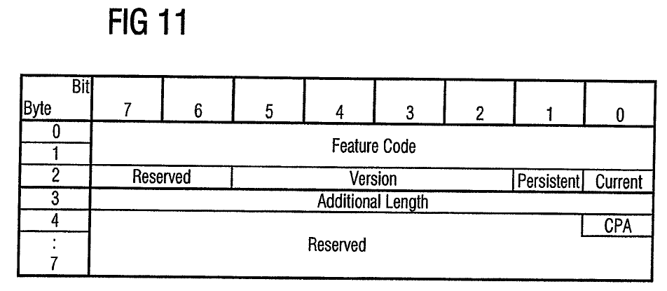

An embodiment of a feature descriptor structure is depicted in FIG. 11. The structure in FIG. 11 shows a feature code, which could for example be 0113h (Big-Endian) for an embodiment of Securdisc. The “Current”-field comprises a flag indicating whether an optical disc can be used for Securdisc recording is in the drive. The “Persistent”-field comprises a flag indicating that the status of the current flag may change any time, in other embodiments it may be set to true. Moreover, the “Version”-field may be set to zero for a version of an embodiment. It is meant to change, only if any optical disc drive side changes may occur in the future. The “Reserved”-field is reserved and may contain only zeros in this embodiment. The “Additional Lengths”-field may be set to 4 to allow for future extensions. If the CPA (CPA=Copy Protection Active) is set to true, this flag specifies that the Securdisc copy protection feature can be used with the optical disc that is currently inserted in a drive.

After the Securdisc feature descriptor is read, the host may make sure that it is working with a licensed Securdisc drive. Reading the Securdisc feature descriptor can be mandatory for drive host authentication to work in some embodiments. During drive host authentication, in addition to making sure that both the host application and the optical disc drive are licensed components, a bus key can be established. This bus key is used later to exchange cryptographic data for copy protection. Drive host authentication may be necessary before writing any Securdisc content.

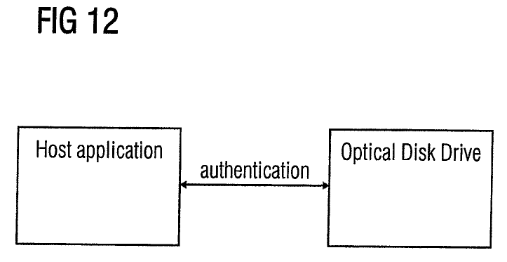

During authentication, both host and drive can be assigned a set of keys. These keys can be used to establish a shared secret, the bus key, which can serve for encrypted communication between host application and the ODD. FIG. 12 illustrates a drive host authentication.

The host may request an AGID (AGID=Authentication Grand ID) from the drive for process identification.

The AGID can from then on, be passed with every REPORT KEY or SEND KEY command to allow the drive to distinguish parallel authentication sequences in an embodiment. The drive may reply with an AGID and a protocol version number. In an embodiment if the host supports a more recent version of the protocol, it may choose to support the older protocol version, if this is permitted by eventual respective compliance rules. In addition to the AGID and the version number, the drive may return its DEVID (DEVID=Device ID). If the host chooses to abort authentication it may do so by issuing a REPORT KEY INVALIDATE AGID command.

In some embodiments the drive can make sure that the protocol version number matches a supported protocol versions.

If the media allows copy protection to be used, i.e. if CPA is set to true in the feature description, the host may issue a REPORT KEY Disc Unique ID command to receive the DUID, encrypted with the bus key KB, which is in the following called drive host authentication Type 1. It will decrypt and store the DUID for use with encryption/decryption of file fragments. The REPORT KEY DUID may only be issued as part of the drive host authentication sequence if the CPA flag is set to true, i.e. within drive host authentication Type 1. Even if the CPA flag is true, the REPORT KEY command may be omitted, using so-called drive host authentication Type 2, which will be described below and in which's case the drive will not generate or read a DUID.

The host can then release the AGID acquired by issuing a REPORT KEY INVALIDATE AGID as the last step of the authentication sequence. Drive host authentication can be performed through the REPORT KEY and SEND KEY commands as e.g. defined in MMC/MtFuji. A new key class for SecurDisc can be defined to distinguish the new authentication method from existing ones. The intermediary key class value for SecurDisc can be set to 21h, which is currently reserved in MMC/MtFuji. If any SEND KEY or REPORT KEY commands are sent in the wrong order, the drive may terminate the inappropriate command with CHECK CONDITION status.

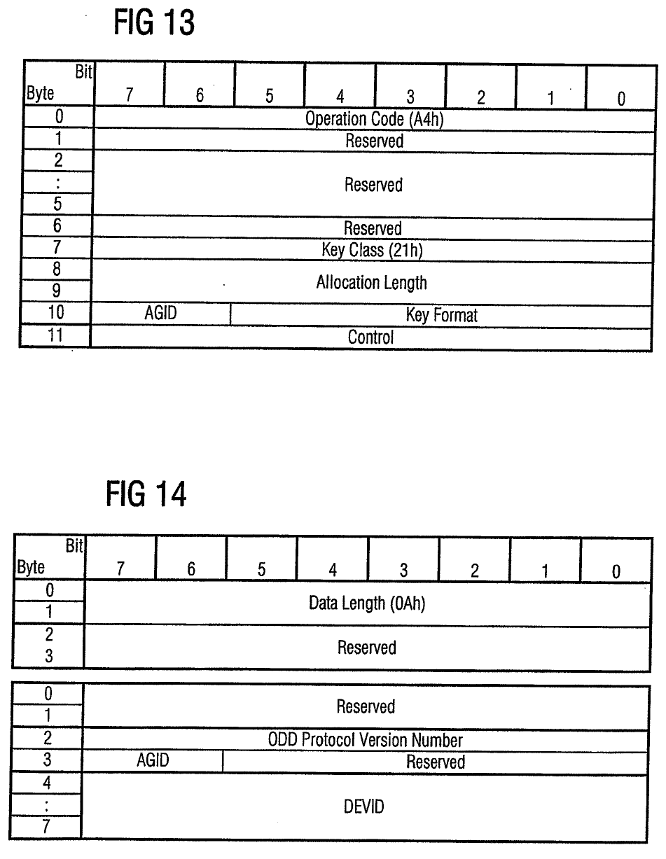

FIG. 13 shows an embodiment of a structure of a REPORT KEY command. The command decryptor block of the REPORT KEY command can be used to address information from the ODD according to FIG. 13. The operational code may be set to A4h in an embodiment. The key class can specify the key class and may be set to 21h for an embodiment of SecurDisc. The allocation length specifies the maximum transfer size for drive to host communication as a Big-Endian WORD value. It can match the size of the buffer reserved on the host side for receiving the data returned by the drive. If this field is zero, no data will be transferred. This condition does not necessarily have to be an error.

The “Key Format”-field specifies the kind of information requested by the host as a 6 bit Big-Endian value. The “AGID”-field can comprise the authentication grant ID, for the REPORT KEY AGID command, the AGID may be set to zero, which will be detailed below. For all other REPORT KEY requests, it can be set to the AGID returned by the REPORT KEY AGID. The “Control”-field comprises a control byte as specified by MMC/MtFuji. Its semantics depend on the bus type used for sending the MMC command.

The ODD may reply to a REPORT KEY AGID and protocol version command with a reply packet, of which an embodiment of a structure is detailed in FIG. 14. The data length may specify the size of the reply packet without the “Data Length”-field itself. This value may be 0Ah in one embodiment for the REPORT KEY AGID reply packet. The “Reserved”-field comprises reserved bits, which may be set to zero in this embodiment. The “ODD Protocol Version Number”-field may specify the protocol version for the authentication sequence spoken by the ODD. If the host supports a more recent version of the protocol but still supports the protocol version supported by the ODD, the host may choose to use the old protocol version to complete the authentication sequence. For a version of the embodiment, the protocol version number can be 00h.

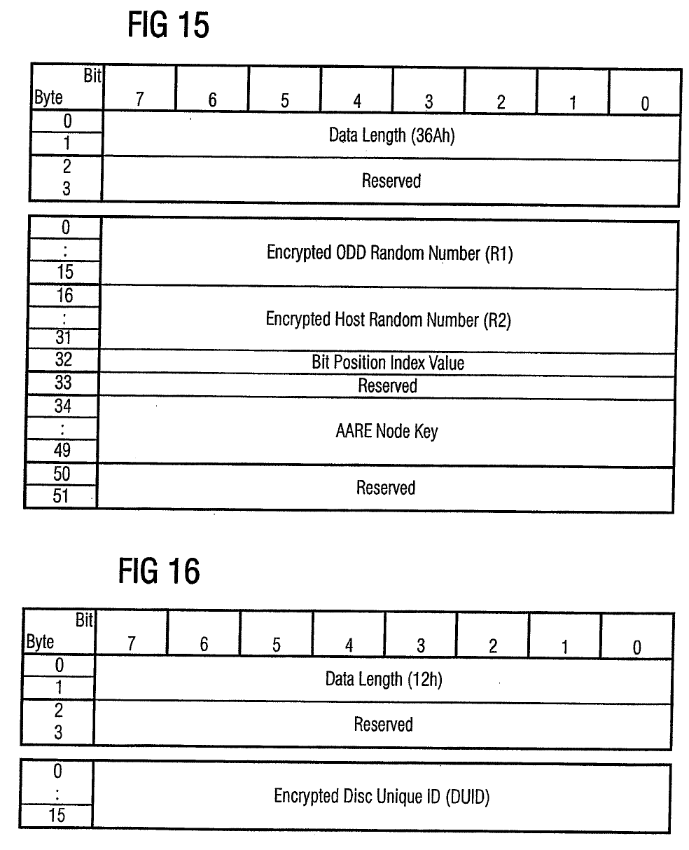

The AGID contains the AGID reserved for this authentication process by the ODD. The AGID can be passed to all following REPORT KEY and SEND KEY commands. The DEVID specifies the device ID assigned to the ODD. The ODD may reply to a REPORT KEY ODD Key Contribution command with a reply packet, which is detailed in FIG. 15. The “Data Length”-field can specify the size of the reply packet without the “Data Length”-field itself. This value can be 36h for the REPORT KEY ODD Key Contribution reply packet in this embodiment. The “Reserved”-field comprises reserved bits, which may all be set to zero. The “Encrypted ODD Random Number”-field may contain a 128 bit random number R1 generated by the ODD, encrypted using a secret key PK2 that has been assigned to the application. The “Encrypted Host Random Number”-field may contains a 128 bit random number R2 previously sent to the ODD by the host, encrypted using a secret key PK2 that has been assigned to the application as follows, where R1 and R2 are encrypted in AES-CBC mode. The host must use

R1||R2=AESCBCDecrypt (PK2, R1||R2)

to obtain the correct result.

A “Bit Position Index Value”-field may specify the bit position corresponding to the node key in the application revocation block returned by the ODD. It is also the index inside the key contribution array used by the application to calculate PK2. Again, the “Reserved”-field comprises all reserved bits which may all be set to zero. The “AARB Node Key” specifies the node key returned by the ODD, which may be combined with the key contribution array stored inside the application and allows the application to calculate PK2.

The ODD replies to a REPORT KEX ODD Disc Unique ID with a reply packet, which is exemplified in FIG. 16. FIG. 16 shows a “Data Length”-field, which may specify the size of the reply packet without the “Data Length”-field itself. This value may be 12h for the REPORT KEY Disc Unique ID in the reply packet of this embodiment. Again a “Reserved”-field indicates reserved bits, which can all be set to zero. The “Encrypted Disc Unique ID” contains the 128 bit DUID, encrypted with the bus key KB. The REPORT KEY INVALIDATE AGID command invalidates the AGID. The ODD replies to a REPORT KEY INVALIDATE AGID command with an empty reply packet and “GOOD”-status indication. After that, the host may no longer use the AGID to issue any SEND KEY or REPORT KEY commands until it is reassigned to the host as a result of another REPORT KEY AGID and protocol version command.

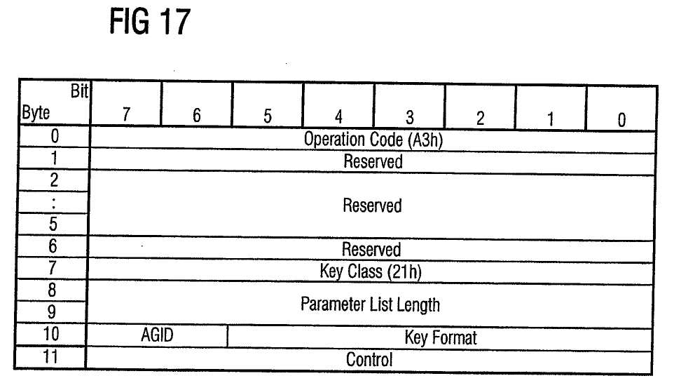

The command descriptor block of the SEND KEY command used to send information to the ODD is depicted in FIG. 17. The “Operation Code”-field may be set to A3h in this embodiment. The “Key Class” specifies the key class and may be set to 21h for SecurDisc in an embodiment. The “Parameter List Length”-field specifies the number of bytes to be transferred from the host to the ODD as a Big-Endian WORD value. In some embodiments if this field is zero, no data may be transferred. The “Key Format”-field specifies the kind of information sent to the ODD as a 6 bit Big-Endian value. The “AGID”-field contains the authentication grant key and can be set to the AGID returned by a REPORT KEY AGID for all SEND KEY requests. The “Control”-field contains a control byte as specified by MMC/MtFuji. Its semantics depend on the bus type used for sending the MMC command.

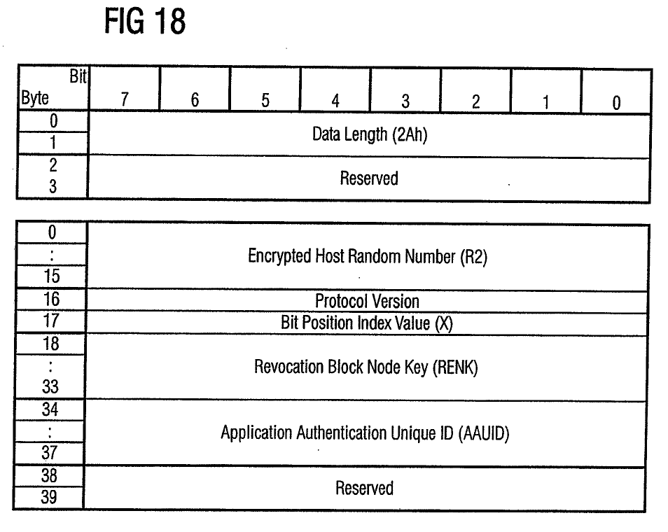

Attached to a SEND KEY host random number and protocol version command the host may send an information packet, which is exemplified in FIG. 18. The “Data Length”-field can specify the size of the information packet without the “Data Length”-field itself. This value may be 2Ah for the SEND KEY host random number and protocol version information packet. The “Reserved”-field indicates the reserved bits, which are all set to zero. The “Encrypted Host Random Number”-field may contain a 128-bit random number R2 created by the host, encrypted using the secret key PK1 that has been assigned to the ODD. The “Protocol Version”-field may contain a protocol version and can be set to 00h in this embodiment. The “Bit Position Index Value”-field specifies an index within the PK1[] array assigned to the ODD that should be used by the drive to build PK1. The “Revocation Block Node Key”-field specifies the node key associated with position x in the DRB as a 128 bit key value. The “Application Authentication Unique ID” may specify an application authentication unique ID which may be used by the ODD to carry out AARB parsing.

Before any of the SecurDisc features is used for recording, the host implementation can ensure that the drive is a licensed SecurDisc drive and that the media can be used for SecurDisc recording or has been written using the SecurDisc feature. A reader implementation needs a SecurDisc drive only if the copy protection feature of SecurDisc is used on the media to be read. Depending on whether the implementation is a reader or recorder implementation, a number of different checks can be carried out before reaching initialized state.

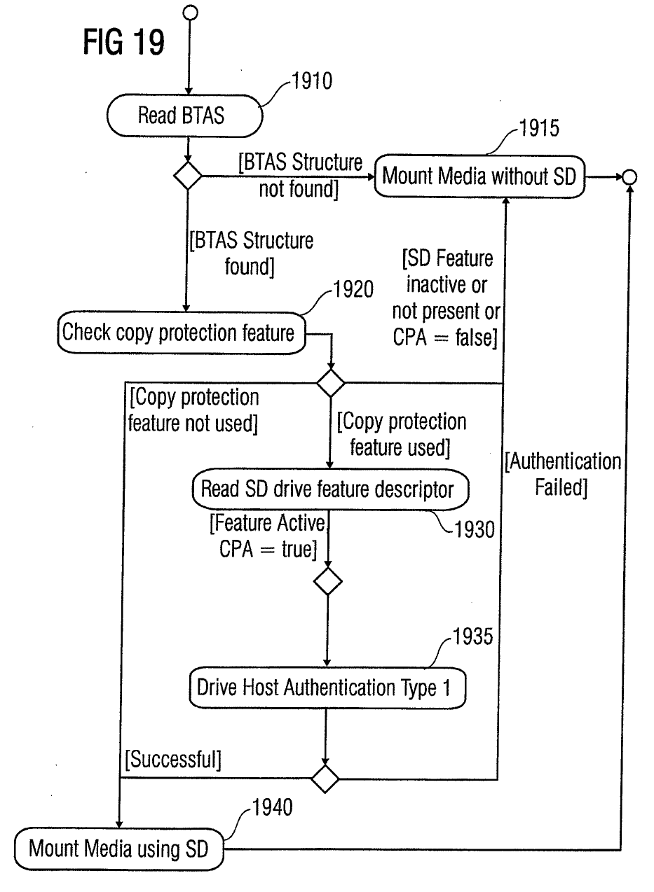

FIG. 19 shows an embodiment of an initialization and SecurDisc feature detection implementation in terms of a flow chart. The flow chart illustrates the reader perspective of a SecurDisc initialization sequence. This sequence is repeated every time a disc change event occurs. In a first step 1910 the reader tries to read the BTAS. By reading the BTAS, the host makes sure that the media in the drive has been written with SecurDisc enabled. If the BTAS structure is missing, the media can be mounted without SecurDisc support in a step 1915. If the BTAS structure is found, the host checks the global feature flag mask of the SecurDisc FFIT to determine whether copy protection is used in a step 1920. If the copy protection feature is used, the host retrieves the SecurDisc drive feature descriptor in a step 1930 and checks whether the SecurDisc feature is supported and whether the current media type supports the copy protection feature, i.e. whether the CPA flag is set to true. If the drive does not support SecurDisc at all, or no copy protection compatible media is in the drive, the media is mounted without SecurDisc support in step 1915. Otherwise a drive host authentication Type 1 procedure can be carried out in step 1935. In case authentication fails the drive is considered not capable of processing copy protected SecurDisc media, the media is mounted without SecurDisc copy protection support in step 1915. Type 1 drive host authentication reads the Disc Unique ID from the media. If the authentication is successful, the media is mounted using SecurDisc in step 1940. In case the first copy of the BTAS structure cannot be read, for example due to a defect in the media, the backup BTAS structure can be sought by scanning the media backwards, e.g. starting with the last written LSN.

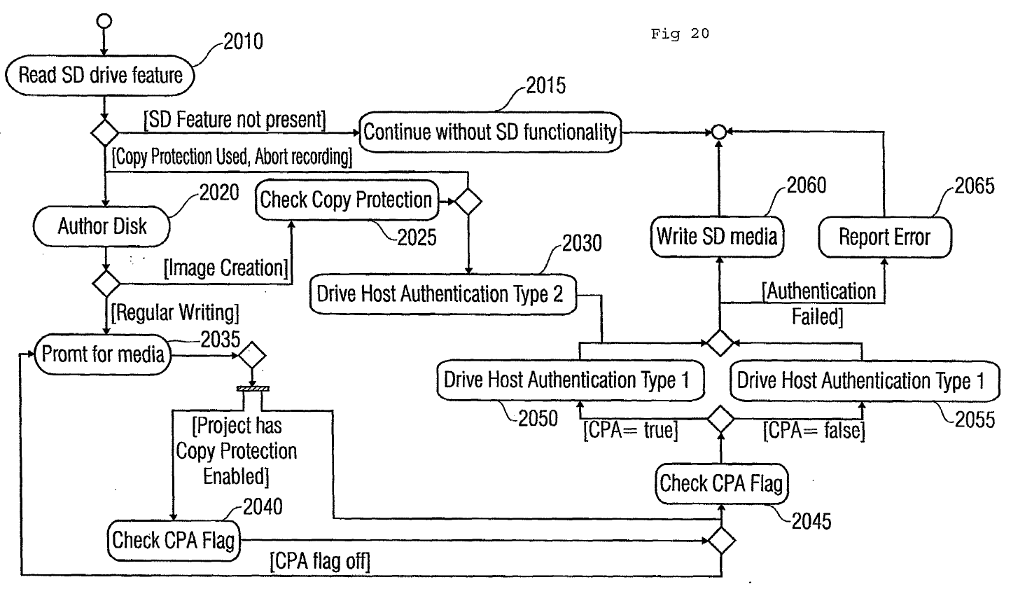

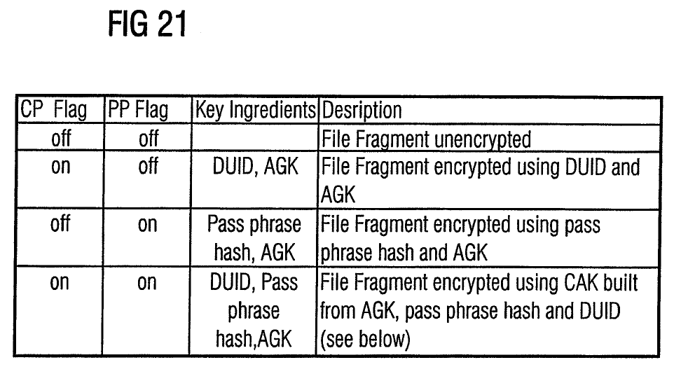

In contrast to a reader implementation, a recording application does not depend on the SecurDisc media type when authoring a medium. Rather, it would usually prompt the user to insert the correct type of blank media as necessary. In an embodiment of an initialization sequence for recording applications is depicted in FIG. 20. Note that creating SecurDisc images may be permitted only if a SecurDisc recorder is attached to the system. In this case, the SecurDisc recorder will be used to perform drive host authentication Type 2 to make sure it is authentic. Writing an image may not be possible with SecurDisc compilations that support copy protection.

FIG. 20 shows the host retrieving the SecurDisc drive feature descriptor in step 2010 as described above, and the host checks whether the SecurDisc feature is supported or not. If the drive does not support SecurDisc at all, the authoring process continues without SecurDisc support in step 2015.

The application allows the user to author and configure a project in a step 2020. The result is a project with a unique combination of SecurDisc features used. When creating a SecurDisc image, copy protection may not be used which is checked in step 2025. If the image is copy protected, the recording is aborted, otherwise drive host authentication Type 2 according to step 2030 is carried out. If no image is created, the user is prompted for a media that supports SecurDisc in step 2035. The media is then recognized based on the feature descriptor as described above having a SecurDisc feature set to active.

If the project is configured to be copy protected, even if it is partially copy protected, only media having the CPA flag set to active in the feature descriptor as described above may be accepted for writing. Therefore, the CPA flag is checked in step 2040, if the project has copy protection enabled. If copy protection is enabled but the media does not support copy protection, it is prompted again for other media in step 2035. Otherwise, the CPA flag is checked in step 2045 if the CPA flag is true drive host authentication Type 1 is performed in step 2050, otherwise drive host authentication Type 2 is performed in step 2055. Type 1 drive host authentication reads the disc unique ID from the media. In case the authentication fails, the drive is considered not capable of processing SecurDisc media, the media is mounted without SecurDisc support. If any authentication is successful, the host writes the project to the SecurDisc media in a step 2060 and if the drive host authentication fails, the host will report an error to the user in step 2065. The application could also give hints on how to get SecurDisc to work again in case a component has been revoked.

In order to calculate a certain content access key (CAK=Content Access Key) encrypting a particular file fragment, the SecurDisc feature flag mask stored in the FFIT as described above, can be used to determine, which key ingredients may be combined to build the CAK. In an embodiment there are two sources of key ingredients, a hash generated from the author supplied pass phrase and the DUID. These two key ingredients can be combined freely for each individual fragment. FIG. 21 shows all combinations of the copy protection flag and the pass phrase flag and their according descriptions. The first combination in the table of FIG. 21 is trivial, since the file fragment is an unencrypted file. When encountering a file fragment with a described flag combination, no encryption has been applied to that file fragment and it can be used immediately without any further transformation. In the remaining cases, the CAK is calculated depending on the Copy Protection (CP) and the Pass Phrase (PP) flags taking into account the DUID, the pass phrase hash or both, are combined with the AGK (AGK=Authorization Grant Key) as will be described in detail in the following.

The CAK for file fragments, can for example be calculated as follows, wherein each key ingredient has e.g. a width of 128 bits:

CAK=KI₀ XOR KI₁ XOR [. . . ] XOR KIₙ₋₁,

wherein n is the number of ingredients to the access key.

For file fragments that have the PP flags set in the FFITE, the host may calculate a 128 bit key ingredient KIₓ from the user supplied pass phrase. For this purpose, a 16-bit unicode representation of the user pass phrase may be copied into a buffer, which is then padded with zero valued bytes to be a multiple of 128 bits. The key ingredient KIₓ is then calculated as follows:

KIₓ=AESHash(buffer).

User pass phrases are case sensitive and can have a minimum length of 16 characters.

Before using the key ingredient KIₓ the host may verify that the correct pass phrase is supplied by the user. This can be done by decrypting the encrypted SecurDisc PVC as described above using the key ingredient KIₓ as follows:

PVC′=AESDescrypt(KIₓ, EPVC).

The value PVC′ is then compared to PVC. If PVC equals PVC′, the correct pass phrase has been provided by the user.

For file fragments that have the PP flag set in the FFITE, the host may obtain the DUID from the drive using the protocol as described above. The ingredient KIₓ may then be calculated as follows:

KIₓ=EASHash (DUID).

If the original author of a disc has set a recovery pass phrase for copy protection, the SecurDisc “Copy Protection Recovery”-field of the FFITE as defined above, may be used to retrieve the DUID without obtaining it from the drive as specified above. In this mode of operation, the DUID may be obtained from the “SecurDisc Copy Protection Recovery”-field (BCPRF=SecurDisc Copy Protection Recovery field) as follows:
1. If all bits of BCPRF are zero, no recover pass phrase has been set. The copy protection may not be undone.
2. Calculate a copy protection recovery key (CPRK=Copy Protection Recovery Key) from a pass phrase entered by the user as specified above.
3. Calculate the DUID as follows:

DUID=AESDecrypt (CPRK, BCPRF).

To obtain the AGK (AGK=Authorization Grant Key), the host processes the ARB as described above. The resulting AGK is created from the AUID and the AGKC (AGKC=AGK Contributor), both of which may be licensed cryptographic secrets and constants as described above. For encryption and decryption of individual logical sectors on the disc, a key that is cryptographically derived from the CAK as described above can be used.

To calculate the key used for a particular sector, AES-128 in counter mode is used to derive the sector key from the CAK as follows:

KSₓ=AESEncrypt (CAK, X),

where X is the LSN of the sector to be decrypted.

The sector key is then used to encrypt/decrypt the corresponding sector using

AESCBCEncrypt (KSₓ, content)/AESCBCDecrypt (KSₓ, content).

If the CS flag of the corresponding FFITE of a file fragment is set, the fragment can be verified using a 128-bit checksum stored in the same FFITE.

The checksum can be calculated from the content of a file fragment for instance using the following function:

CHECKSUM=AESHash (FFC),

where FFC is the content of all logical sectors the file fragment consists of concatenated. If the last logical sector is not used entirely, it can be padded with zeros. Content of all logical sectors means the user payload of all logical sectors as written on the media with no pre-processing such as decryption applied.

A host can verify the validity of a file on a SecurDisc enabled disc by checking all corresponding file fragments against their file fragment checksums. If any of the file fragments has a wrong checksum, the file is considered corrupted. If a defective packet is found while reading the file the host may use redundancy information if present to reconstruct the correct checksum.

The drive can calculate the DUID as part of the authentication sequence when CPA equals true. The DUID may be generated as a 128 bit random number when the REPORT KEY DUID is issued and no DUID is present on the disc.

When receiving a FEATURE REQUEST command from the host, the ODD may try to read the DUID from the media. It can cache the DUID in its RAM until it is requested by the host using the Report Key DUID command. Alternatively, the ODD may read the DUID during drive host authentication when executing the REPORT KEY DUID command as specified above. The ODD may only do the latter if calculating the CPA flag does not necessitate knowledge of the DUID state.

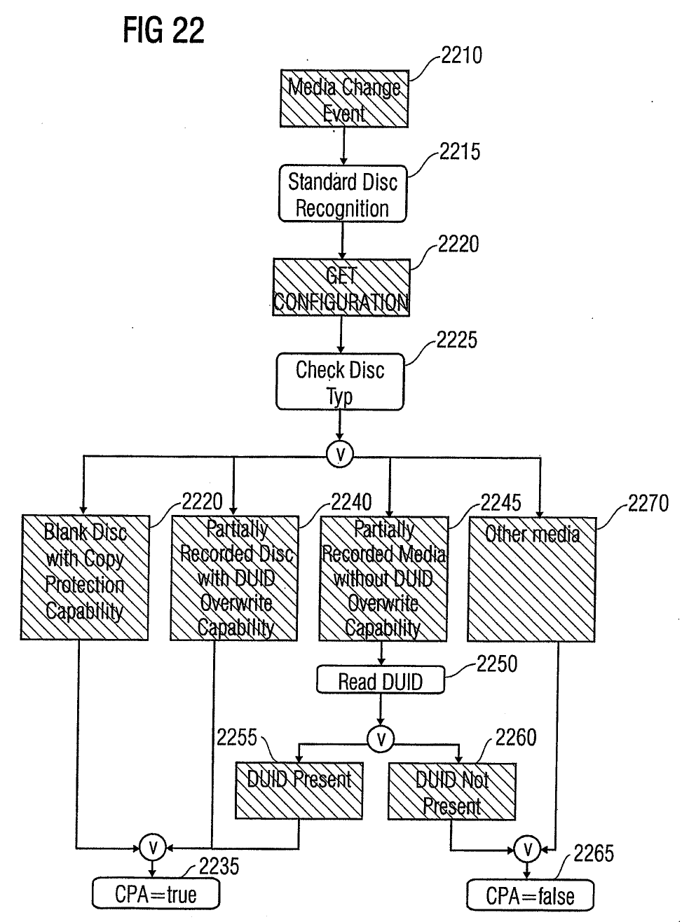

When the host requests the SecurDisc feature descriptor, the ODD calculates the CPA flag that is part of the feature descriptor and determines the type of drive host authentication that is performed as indicated in FIG. 22. In a first step 2210, an immediate change event occurs which is followed by a standard disc recognition step 2215. After a disc has been recognized, the configuration is read in a step 2220 and the disc type is checked in a step 2225.

Four different types of discs may be distinguished. In step 2230 a blank disc with copy protection capability is detected. Therewith the CPA is set to true in step 2235. In step 2240, a partially recorded rewriteable media with DUID overwrite capability is detected, and accordingly the CPA flag is set to true in step 2235 as well. In step 2245 a partially recorded write once media or rewriteable media without DUID overwrite may be detected. Accordingly, in step 2250 the DUID is read and if the DUID is present in step 2255 the CPA is set to true in step 2235 accordingly. If the DUID is not present as indicated in step 2260, the CPA flag is set to false as indicated in step 2265. If any other media is detected in step 2270 the CPA is also set to false in step 2265.

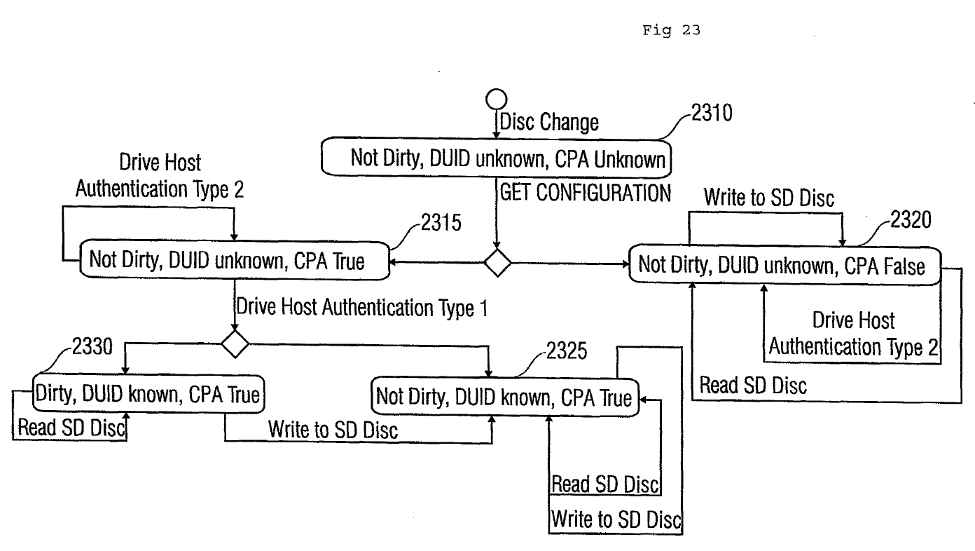

FIG. 23 illustrates a flow chart of the different states of an ODD with respect to an embodiment of SecurDisc. Again, there are two types of drive host authentications in which Type 1 in the flow chart of FIG. 23 means drive host authentication with reading the DUID, whilst Type 2 means drive host authentication without reading the DUID, in line with what was described above. Type 1 authentication may only take place if the CPA flag is set to true, Type 2 authentication may be performed whenever Type 1 authentication may take place but it never changes the internal state of the drive. A Type 2 authentication may also take place when the CPA flag is set to false, even when there is no disc in the drive.

Each state of the flow chart in FIG. 23 can be described using three variables. The first one is a flag called “dirty”. If this flag is true, the DUID is known to the ODD, it may have been generated by the ODD but has not been synchronized with the media. If this flag is false, the DUID is either not known to the ODD or it is in sync with the DUID stored on the media. In other words, if the DUID is known to the ODD, this flag specifies whether the DUID has been written to the media.

The next flag is a “DUID known” flag. If it is set to true, the DUID is known to the ODD because it has either been generated or read from the media. If it is set to false, the DUID is unknown because it has either not yet been read from the media, or because it is not present on the media. Therewith the flag specifies whether the DUID is known to the ODD.

A “CPA” flag specifies whether the media in the drive can be used for copy protection. If it is set to true, the media may be used for writing copy protected files. If it is false, the media cannot be used for writing copy protected files. If the flag is unknown, then the flag has not been evaluation yet.

When a disc change occurs, the first state of the ODD is state 2310, in which the dirty flag is false, DUID is unknown and CPA is also unknown. The host then issues the GET CONFIGURATION command to retrieve the feature descriptor of the SecurDisc feature. The state of the ODD changes in respect to the CPA feature, which is known to be either true or false, when the command is completed, and which is indicated by the steps 2315 in case the CPA is set to true and 2320 in the case of the CPA is set to false. Proceeding further from step 2315, the drive host authentication Type 2 may be performed, however, this type of authentication never changes the state of the ODD. When performing drive host authentication Type 1, the DUID becomes known. If the DUID was read from the media, the dirty flag will be set to false, according to step 2315. If the DUID was generated during the drive host authentication Type 1, the dirty flag becomes true according to step 2330, the SecurDisc media can be read without leaving state 2330. However, if data is written to SecurDisc, the dirty flag is set to false again, and the ODD accordingly converts to state 2325. The state change occurs since the DUID is written to the SecurDisc media. Once this state is reached in step 2325, neither reading data from the SecurDisc, nor writing data to the SecurDisc yields any state changes.

If the CPA flag was detected to be false in the beginning, the ODD changes to state 2320. In state 2320 data can be written to the SecurDisc media and also be read from the SecurDisc media. Moreover, drive host authentication Type 2 may be performed. All these actions will not yield any state changed from state 2320.

Embodiments provide the advantage that copy protection and access control can be controlled by commercial and private users. With the embodiment of SecurDisc, a powerful feature set is provided, which enables copy protection and access control, data safety and data verification, as well as digital signatures and content verification.

Depending on certain implementation requirements of the inventive methods, the inventive methods can be implemented in hardware or in software. The implementation can be performed using a digital storage medium, in particular a disc, DVD or CD having electronically readable control signals stored thereon, which cooperate with a programmable computer system, such that the inventive methods are performed. Generally, the present invention is, therefore, a computer program product with a program code stored on a machine-readable carrier, the program code being operative for performing the inventive methods when the computer program product runs on a computer. In other words, the inventive methods are, therefore, a computer program having a program code for performing at least one of the inventive methods when the computer program runs on a computer.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

1. An apparatus for writing data to a medium, comprising:
a receiver for receiving a write request and encrypted data from a data provider;
a creator for creating a medium ID upon reception of the write request;
a provider for providing the medium ID to the data provider for generating the encrypted data; and
a storage for storing the encrypted data on the medium and for storing the medium ID on the medium upon creation of the medium ID, wherein the encrypted data is encrypted based on the ID.

2. The apparatus of claim 1, wherein the storage for storing is adapted for storing the encrypted data in a data section and the medium ID in an ID section of the medium, wherein the data section is isolated or separated from the ID section.

3. The apparatus of claim 2, wherein the storage for storing is adapted for storing only the medium ID in the ID section subsequently to creating the ID by the creator for creating the medium ID.

4. The apparatus of claim 1, wherein the creator for creating is adapted for creating a medium ID by generating a random or pseudo random number.

5. The apparatus of claim 1, wherein the storage for storing is adapted for storing a combination of the medium ID and a password on the medium.

6. The apparatus of claim 1, further comprising a receiver for receiving a read request from a data reader and a reader for reading a medium ID and encrypted data from a medium.

7. The apparatus of claim 6, further comprising a provider for providing the medium ID and encrypted data from the medium to the data reader.

8. The apparatus of claim 1, being implemented in a chip, ROM or optical drive.

9. The apparatus of claim 1, further comprising an authenticator for authenticating with a data provider or a data reader.

10. The apparatus of claim 1, wherein the receiver for receiving is adapted for receiving an encrypted write request from the data provider and for decrypting the write request.

11. The apparatus of claim 6, wherein the receiver for receiving the read request is adapted for receiving an encrypted read request and for decrypting the encrypted read request.

12. The apparatus of claim 1, wherein the provider for providing is adapted for encrypting the medium ID and for providing the encrypted medium ID to the data provider or data reader.

13. A method for writing data to a medium, comprising:
receiving a write request from a data provider;
creating a medium ID upon reception of the write request;
providing the medium ID to the data provider for generating the encrypted data;
receiving the encrypted data from the data provider; and
storing the encrypted data on the medium and storing the medium ID on the medium upon creation of the medium ID, wherein the encrypted data is encrypted based on the medium ID.

14. A computer program comprising a program code for performing a method for writing data to a medium, comprising: receiving a write request from a data provider; creating a medium ID upon reception of the write request; providing the medium ID to the data provider for generating the encrypted data; receiving the encrypted data from the data provider; and storing the encrypted data on the medium and storing the medium ID on the medium upon creation of the medium ID, wherein the encrypted data is encrypted based on the medium ID, when the program code runs on a computer.

15. An apparatus for providing encrypted data to a data writer, comprising;
a sender for sending a write request to the data writer;
a receiver for receiving a medium ID from the data writer upon sending the write request; and
an encrypter for encrypting plain text data using an encryption key to obtain the encrypted data, the encryption key being based on the medium ID; and wherein the sender for sending is adapted for sending the encrypted data to the data writer.

16. The apparatus of claim 15, wherein the encrypter for encrypting is further adapted for using an encryption key being further based on a password.

17. The apparatus of claim 15, wherein the encrypter for encrypting is adapted for using an encryption key being further based on a revocation key.

18. The apparatus of claim 15, further comprising a sender for sending a read request to a data reader, a receiver for receiving encrypted data and a medium ID and a decrypter for decrypting data based on a decryption key to obtain plain text data.

19. The apparatus of claim 18, wherein the decrypter for decrypting is adapted for using a decryption key being based on a medium ID, a password, or a revocation key.

20. The apparatus of claim 15, wherein the encrypter for encrypting is further adapted for encrypting an information on an encrypted password in the encrypted data.

21. The apparatus of claim 18, further comprising a detector for detecting a copy protection indication from the encrypted data or the plain text data.

22. The apparatus of claim 21, wherein the sender for sending the write request is adapted for not sending a write request when a copy protection indication is detected.

23. The apparatus of claim 21, wherein the receiver for receiving a medium ID is adapted for not receiving the medium ID when the copy protection indication is detected.

24. The apparatus of claim 21, wherein the encrypter for encrypting is adapted for not encrypting data when the copy protection indication is detected.

25. The apparatus of claim 21, wherein the copy indication protection corresponds to a control bit within the encrypted or plain text data, the encrypted or plain text data comprising a plain text control information.

26. The apparatus of claim 15, further comprising an authenticator for authenticating with the data writer an wherein the sender for sending are adapted for sending an encrypted read or write request and the receiver for receiving are adapted for receiving an encrypted media ID.

27. A method for providing encrypted data to a data writer, comprising:
sending a write request to the data writer;
receiving an ID from the data writer upon sending the write request;
encrypting plain text data using an encryption key to obtain the encrypted data, the encryption key being based on the medium ID; and
sending the encrypted data to the data writer.

28. A computer program comprising a program code for performing a method for providing encrypted data to a data writer, comprising: sending a write request to the data writer; receiving an ID from the data writer upon sending the write request; encrypting plain text data using an encryption key to obtain the encrypted data, the encryption key being based on the medium ID; and sending the encrypted data to the data writer, when the computer program runs on a computer.

29. An optical drive comprising an apparatus for writing data to a medium, comprising: a receiver for receiving a write request and encrypted data from a data provider; a creator for creating a medium ID upon reception of the write request; a provider for providing the medium ID to the data provider for generating the encrypted data; and a storage for storing the encrypted data on the medium and for storing the medium ID on the medium upon creation of the medium ID, wherein the encrypted data is encrypted based on the ID, and an apparatus for providing encrypted data to a data writer, comprising: a sender for sending a write request to the data writer; a receiver for receiving a medium ID from the data writer upon sending the write request; and an encrypter for encrypting plain text data using an encryption key to obtain the encrypted data, the encryption key being based on the medium ID; and wherein the sender for sending is adapted for sending the encrypted data to the data writer.
